(19) United States
(12) Patent Application Publication
(10) Pub. No.: US 2009/0128632 A1
(43) Pub. Date: May 21, 2009

(54) CAMERA AND IMAGE PROCESSOR

(75) Inventors: Takeyuki Goto, Yokohama (JP); Takashi Maruyama, Ebina (JP); Makoto Kikuchi, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/273,060

(22) Filed: Nov. 18, 2008

(30) Foreign Application Priority Data
Nov. 19, 2007 (JP) 2007-298783

(51) Int. Cl. H04N 5/225

(52) U.S. Cl. 348/169; 348/E05.024

(57) ABSTRACT

A video signal produced through a shooting operation of a camera is sent to a motion detecting unit which detects a motion included in the video signal to set an area of the motion as a space motion area and inputs information of the area to a distance determination circuit which calculates distance between the motion area and the camera by use of a parallax signal produced from stereo cameras disposed in the camera to send information of the space motion area and the distance to a mask determination circuit. The mask determination circuit conducts a comparison between the space motion area information and the space mask area information and between the distance information of the motion area and that of the space mask area, and resultantly compares three-dimensional positions between the detected motion and the mask to determine a position relationship therebetween.

### INCORPORATION BY REFERENCE

The present application claims priority from Japanese application JP2007-298783 filed on Nov. 19, 2007, the content of which is hereby incorporated by reference into this application.

### BACKGROUND OF THE INVENTION

The present invention relates to an imaging apparatus and an image processor in which mask processing is executed.

Recently, a video monitor or supervisory system employing a monitor or supervisory camera has been broadly used in locations and areas such as stores of a bank, an apartment building, a road, and a shopping district. To display and to record video information regarding such monitor areas in the system, it is essential to set a privacy mask for personal information included in the monitor areas.

However, there exists a disadvantage, that is, when an image of a suspicious person to be monitored enters a privacy mask area, the image of the suspicious person is invisible due to the mask. The disadvantage is discussed in, for example, JP-A-2006-304250 in which “to provide an image processor in which “mask processing (masking) for privacy protection does not damage a supervisory function in a video supervisory system using a supervisory camera” is cited as a problem, and the solution is described as “a motion area is detected from a video signal of the supervisory camera, and a relative position relation between the motion area and a mask area for privacy protection is judged. When no motion area exists or a motion area is located outside the mask area, or when the entire motion area is located within the mask area, the mask area is masked as it is, and when a portion of the motion area is located within the mask area, masking is performed so as to exclude the portion of the area from the mask area to thereby make the entire image of the motion area displayable”.

Also, recently, there has been discussed a probe car system which includes a vehicle mounting a camera to provide current traffic conditions of respective roads. Also in the probe car system, since images obtained by shooting or photographing public places and locations are transmitted, it is required to appropriately protect private information of individuals. In this connection, for example, JP-A-2006-178825 assumes as a problem “to provide a probe system, which photographs the road conditions of unidentified multiple spots by using a probe car mounting a camera and distributes them, to secure the quality of an image, while ensuring the privacy of the photographed image”. In conjunction with the fourth embodiment, JP-A-2006-178825 describes “by use of a parallax image photographed by a plurality of cameras, the distance to an object on the front side. When the distance exceeds the distance in which it is predicted that privacy information of an image is photographed, only the image of the portion is processed”.

As above, according to JP-A-2006-304250, the privacy mask is set on the basis of a two-dimensional mutual positional relationship between the motion area and the two-dimensional privacy mask of the mask area. However, even if the two-dimensional mutual positional relationship is employed, there exists a case in which the mask cannot be appropriately set.

For example, in the mask setup according to JP-A-2006-304250, when a portion of the motion area overlaps with the mask area, the motion area portion is excluded from the mask area. However, for example, if the mask area overlaps an edge portion of the photographed image, it is not possible in the edge portion to determine whether or not the masking is to be performed for the moving object. This sets limits on the range of the image to which the mask area is set.

On the other hand, in the privacy mask setup according to JP-A-2006-178825, by use of two cameras mounted in a probe car, the distance to a car running before the probe car is measured. When the distance is equal to or less than the predetermined distance, the masking for privacy protection is performed. This is limited to the masking on the basis of the distance between the target car and the probe car, namely, the one-dimensional mutual positional relationship.

### SUMMARY OF THE INVENTION

It is therefore an object of the present invention to provide a camera and an image processor in which the masking is performed on the basis of a three-dimensional mutual positional relationship between a mask area and a monitor object to be monitored.

To achieve the object of the present invention, the present invention is implemented in the configurations defined, for example, by the appended claims.

In an image processor according to the present invention, it is possible to execute the mask processing on the basis of a three-dimensional mutual positional relationship between a mask area and a monitor object.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of an imaging device;

FIG. 2 is a diagram showing a principle of stereo cameras employed to calculate the distance of a space motion area or a space mask area;

FIG. 3 is a diagram showing an example of the mask area, specifically, a coordinate area and coordinates to be used in the mask processing;

FIG. 4 is a diagram schematically showing a screen display example to explain operation of a first embodiment;

FIG. 5 is a block diagram showing a second configuration example of an imaging device;

FIG. 6 is a diagram showing a mask processing method for privacy protection in an art museum adopting the imaging device;

FIG. 7 is a diagram showing a mask processing method for privacy protection in a bank employing the imaging device; and

FIG. 8 is a flowchart showing an example of the mask processing.

### DESCRIPTION OF THE INVENTION

Referring now to drawings, description will be given of embodiments according to the present invention.

### First Embodiment

The imaging device is an information terminal including, for example, a monitoring device such as a monitor camera, a camera such as a digital camera or a camcorder, or another cameral module. The image processor is an information processor to execute image processing, for example, a Personal Computer (PC) or a chip to process a video signal received from an external device. In the imaging device to be described below, it is possible by including information which represents the depth of a mask area and a motion area to determine the positional relationship relative to the imaging device between the target to be protected by the mask and the moving object. Also, the imaging device is configured such that on the basis of the positional relationship, an associated portion of the mask area is excluded.

In the description below, the space mask area is an area to be masked in an imaging space. The space mask area is indicated by use of the distance to a target of the mask protection in the space mask area and coordinates of the area in the photographed image. The space motion area is an area occupied by a mobile or moving object which moves in the imaging space. The space motion area is indicated using the distance to the moving object and coordinates of the area in the photographed image. The mask processing or the masking is processing in which a video image is partly or entirely processed, for example, to be displayed in black or to be hatched. Next, description will be given of an example in which an imaging device is applied to a monitor camera or a monitor system.

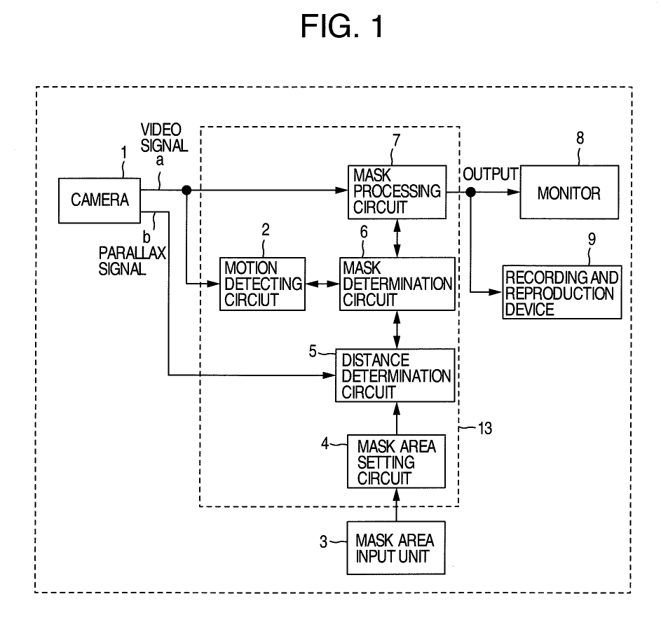

FIG. 1 shows a configuration example of an imaging device.

The camera 1 serves an image shooting function (not shown) and a function to measure and to determine the distance of an object displayed on the monitor. In the description of the embodiment, the camera 1 is assumed as a stereo camera. The camera 1 conducts a supervisory or monitor operation using image signal a to shoot an object and parallax signal b to determine the distance.

A motion detecting unit 2 includes a signal processor, for example, a Micro Processor Unit (MPU) or an Application Specific Integrated Circuit (ASIC). The motion detecting circuit 2 obtains a difference between images of the shooting object, for example, by using a difference in time series between video information items, to thereby detect a mobile portion of the object.

A mask area input unit 3 includes, for example, an input device such as a button and/or a cursor key. Before starting a monitor operation according to an input signal to the camera 1, the user conducts an initial setup in which the user designates a space mask area for image signal a by use of the mask area input unit of the camera 1, the image signal being displayed as an output signal on a monitor 8 or the like.

A mask area setting circuit 4 includes a signal processor, for example, an MPU or an ASIC. The circuit 4 receives a signal from the mask area input unit 3 and converts the signal into mask area setting information of coordinates or the like, which is superimposable onto a video signal and which is projectable, and then sends the information to a distance determination circuit 5.

After the initial setup, the camera 1 starts a monitor operation. Video signal a produced from the camera 1 is sent to the motion detecting unit 2. The detecting unit 2 detects a motion in video signal a to produce information indicating an area in which a mobile object exists in the imaging space and outputs the information to a mask determination circuit 6.

The mask determination circuit 6 includes a signal processor, for example, an MPU or an ASIC. The circuit 6 determines an overlapped area between the space mask area and the space motion area. Specifically, the circuit 6 determines, for example, whether or not the space mask area set as above overlaps with the mobile object in a two-dimensional image produced by projecting or imaging the area and the object. If it is determined that the area in which the mobile object exists overlaps with the space mask area, the mask determination circuit 6 produces information indicating a position of the mobile object on the image and outputs the information to the distance determination circuit 5.

The distance determination circuit 5 includes a signal processor, for example, an MPU or an ASIC. The circuit 5 determines, in a position in a three-dimensional space, a mobile object as a monitor target by use of parallax signal b from the stereo camera disposed in the camera 1. Concretely, the circuit 5 calculates the distance between the imaging device and an object or an area which is to be masked for privacy protection in the shooting space, and outputs the distance to the mask determination circuit 6. Also, the distance determination circuit 5 calculates the distance between the camera 1 and a mobile object in the imaging space to output the distance to the circuit 6.

The mask determination circuit 6 calculates information indicating the area to be masked, on the basis of the information indicating the space mask area and the information indicating the space motion area, and then outputs the information to a mask processing circuit 7. Specifically, the mask determination circuit 6 produces information indicating whether or not an excluding operation, which will be described later, is to be carried out for the portion of the area associated with the masking operation.

The mask processing circuit 7 includes a signal processor, for example, an MPU or an ASIC. The circuit 7 executes mask processing for a video signal inputted thereto, according to the input video signal and information produced from the mask determination circuit 6.

A monitor 8 includes a display, for example, a liquid-crystal display or an organic Electro Luminescence (EL) display. The monitor 8 displays thereon an image masked by the mask processing circuit 7.

Additionally, the mask processing circuit 7 sends a monitor video signal including the mask information to the monitor 8 and records and saves the signal in a recording and reproducing device 9 such as a videotape recorder and a digital recorder.

The motion detecting unit 2, the mask area setting circuit 4, the distance determination circuit 5, the mask determination circuit 6, and the mask processing circuit 7 may be implemented, for example, by use of a single Central Processing Unit (CPU). Or, it is also possible to combine desired ones of the constituent circuits with each other such that the resultant modules are implemented using a CPU.

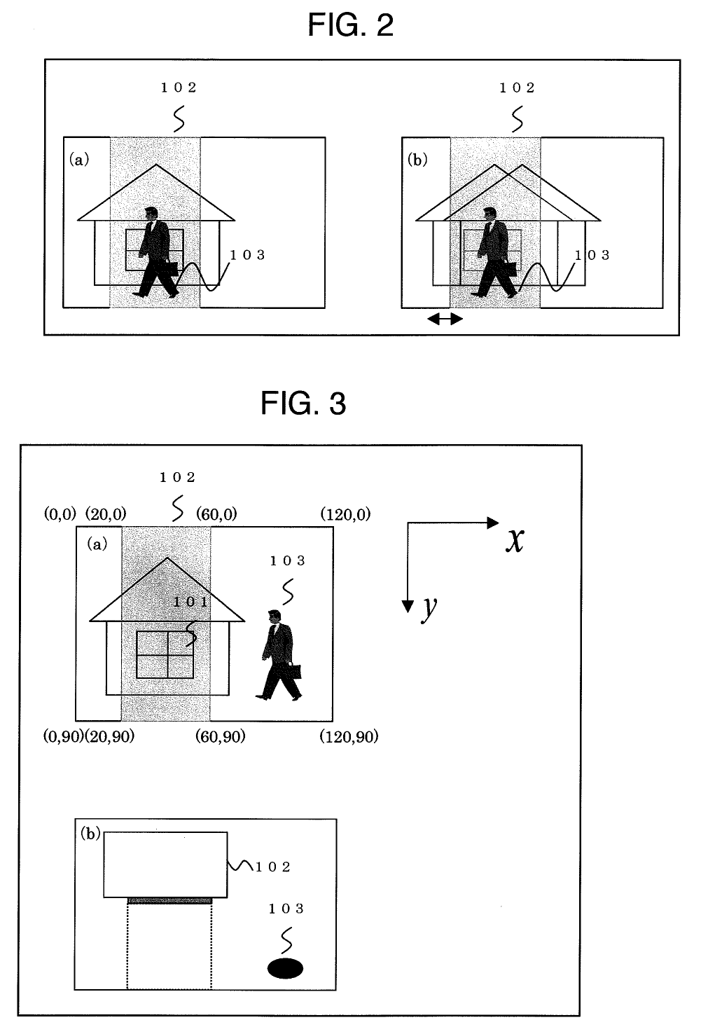

Referring now to FIG. 2, description will be given of the principle of the stereo camera employed to calculate the distance from the camera 1 to the protection target corresponding to the space mask area or the distance from the camera 1 to the mobile object corresponding to the space motion area. The stereo camera, for example, calculates the distance between two cameras constituting the stereo camera and the focal length when the shooting object is in focus to calculate the distance of the object relative to the camera 1 on the basis of trigonometric ratios.

In (a) of FIG. 2 showing an example of motion detection, a moving person 103 is detected to be displayed on the screen, the person 103 overlapping with a house. In this situation, the person 103 is assumed as an image not to be protected on the screen and hence is excluded.

Section (b) of FIG. 2 shows a state in which images obtained, when the person 103 is focused, respectively by two stereo cameras are combined with each other. If the person 103 is in front of the house relative to the camera 1 and the distance between the person 103 and the house is small, the right and left images only slightly differ from each other. However, if the distance between the person 103 and the house is large, the difference between the images increases. To measure the relative distance between the house as the protection target and the person 103, there exists a method to measure the distance from the camera 1 to the house and the distance from the camera 1 to the person 103. However, as can be seen from (b) of FIG. 2, the relative distance can also be determined on the basis of the difference between the images.

The distance may also be numerically produced.

Referring next to FIG. 3, description will be given of a specific example of the setting of a space mask area.

Section (a) of FIG. 3 shows a screen display example of the setting of a space mask area. In this operation, it is possible to input numeric values of a mask in a menu display screen to set a mask area on the monitor 8, for example, a numeric value ranging from 0 to 120 along the x axis and a numeric value ranging from 0 to 90 along the y axis. Description will be given of a situation to set a privacy mask to a window 101 of the house as a privacy protection target.

First, the distance to the window of the house which is the privacy protection target in the object to be monitored is calculated by use of the stereo cameras to determine distance information indicating the depth to be included in the space mask area. The user then inputs numeric values, using a keyboard of the personal computer, of coordinates to define the mask position, i.e., 20 and 60 as the start and end positions along the x axis and 0 and 90 as the start and end positions along the y axis. Through the setup operation, the information of coordinates of the space mask area in the two-dimensional image and the distance information indicating the depth of the area are determined. By use of information items described above, it is possible to express a predetermined area in the imaging space.

Section (b) of FIG. 3 schematically shows an image of (a) of FIG. 3 viewed from above. The space mask area 102 is projected onto a predetermined area of the imaging space. Although the mask area 102 has the depth in (b) of FIG. 3, it is also possible that the area 102 is set as a plane not having the depth.

In the setup of the area, the user may employ a method in which the coordinates of positions of the space mask area are first determined and then the depth thereof is determined. Moreover, the mask processing method is performed not only by designating coordinates, but the user may also adopt a method in which one screen is subdivided into 32 or 64 blocks along the x and y axes to mask only the desired blocks.

The distance information indicating the depth of the space mask area can be determined according to a relative position with respect to the distance of the target to be masked for privacy protection. For example, if it is desired to set the depth for a position which is not just at the window and which is less apart then the window 101 and two meters apart therefrom, the distance to the window 101 calculated by the stereo cameras is corrected, i.e., two meters are subtracted from the calculated value.

Also, the distance information indicating the depth can be set with desired numeric values, without using the relative positions described above. There exists, for example, a situation wherein a transparent window 101 appears on the overall screen and it is difficult to set the window in focus, and hence it is difficult to automatically set the depth by the stereo cameras. In such situation, the method of setting the depth with desired numeric values is particularly useful.

Furthermore, the space mask area may be set through “drag and drop” using a mouse or by use of a touch panel.

As above, the mask area setting unit 4 sets the space mask area according to the user's operation in which the user directly sets a target for mask protection or the user designates a portion of the space as the imaging or photographing object.

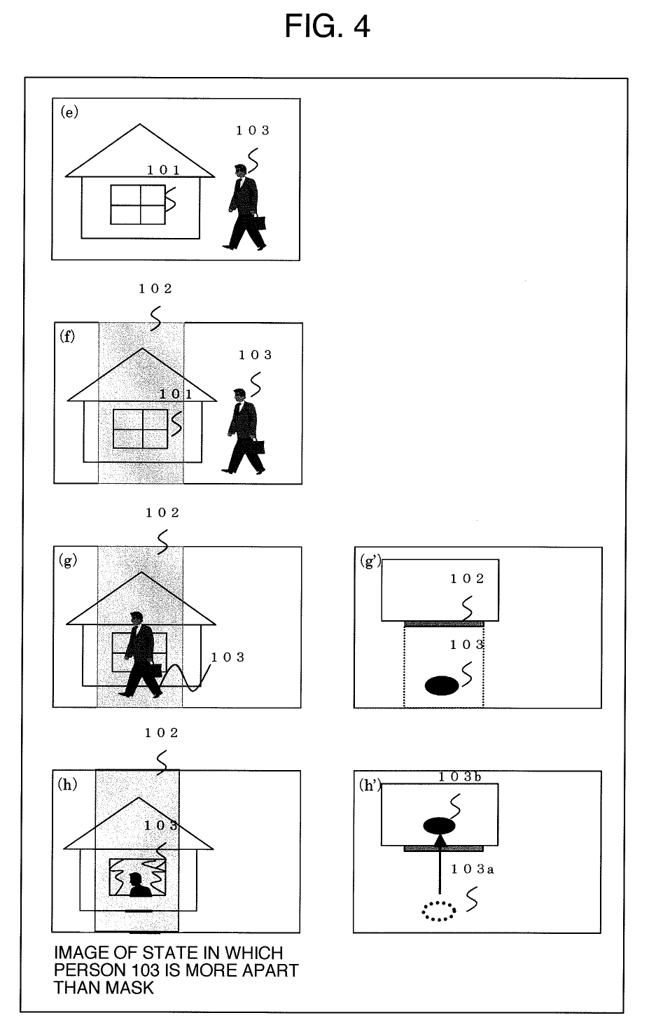

Referring next to FIG. 4, description will be specifically given of an example of operation in the imaging device shown in the block configuration of FIG. 1.

Section (e) of FIG. 4 shows a screen image not masked, namely, video signal a produced by shooting an object by the camera 1 is directly displayed on the monitor 8. A portion of the image of the window 101 is an area for privacy protection. The person 103 is moving and an image thereof is to be continuously displayed so long as the person 103 is less apart from the camera 1 than the space mask area. In this situation, an area in which the person 103 exists in the imaging space is defined as a space motion area.

Based on the space mask area and the space motion area, the mask determination circuit 6 determines a range to be masked in the display image. Concretely, the circuit 6 executes processing to determine whether or not the space mask area and the space motion area overlap with each other in the two-dimensional image. For example, the circuit 6 compares the two-dimensional coordinate information of the space mask area in the planar image with that of the space motion area in the planar image to determine the overlapping condition between these areas.

If the space mask area overlaps with the space motion area in the two-dimensional image, the mask determination circuit 6 compares the information of distance included in the space mask area with that included in the space motion area to determine which one of the areas is nearer to the camera 1. In the stage to determine the overlapping state between the areas, the distance information representing the depth is not necessarily used.

Section (f) of FIG. 4 is a display image presented by setting the space mask area as described in conjunction with FIG. 3 to conceal the window 101 as the protection target by the mask 102. The motion detecting unit 2 detects the person 103 on the basis of video signal a produced from the camera 1. The motion detecting unit 2 to detect a moving object in the space to be photographed sends information indicating the position of the person 103 in the display image to the mask determination circuit 6. The circuit 6 determines whether or not there exists an overlapped portion between the person 103 and the mask 102 and sends information of the overlapped portion to the distance determination circuit 5. The circuit 5 focuses the stereo cameras of the camera 1 on the person 103 to measure the distance to the person 103 using parallax signal b. The circuit 5 then outputs information indicating the space motion area corresponding to the person 103 to the mask determination circuit 6.

If it is determined that the space motion area of the person 103 does not overlap with the space mask area in the two-dimensional image, the mask determination circuit 6 produces information indicating that the space mask area as the protection target is to be entirely masked. Resultantly, as shown in (f) of FIG. 4, the person 103 and the mask 102 are displayed on the screen of the monitor 8. Incidentally, in the embodiment, “an overlapping state” indicates that the mask area overlaps with the motion area in the two-dimensional video image produced by the camera 1.

Section (g) of FIG. 4 shows an image when the moving person 103 overlaps with the mask 102. Section (g′) of FIG. 4 shows an image of (g) of FIG. 4 viewed from above, namely, the person 103 is in front of the mask 102.

At this point of time, the motion area and the distance information of the person 103 are detected by the motion detecting unit 2 and the distance determination circuit 5. If the mask determination circuit 6 determines that the space motion area of the person 103 overlaps with the space mask area and the distance information of the person 103 and that of the mask area indicate that the person 103 is less apart from the camera 1, the mask processing circuit 7 executes the mask processing excepting the motion area of the person 103. That is, the circuit 7 executes the mask processing in the range of the space mask area displayed on the image and then executes the mask processing on the image excluding the overlapped portion between the space mask area and the space motion area in the two-dimensional image. As a result, as shown in (g) of FIG. 4, the person 103 is displayed on the screen of the monitor 8 as if the person 103 is existing over the mask 102.

At a position before the mask 102, if the person 103 stops moving and hence the motion detecting unit 2 cannot detect the person 103, the detecting unit 2 sends flag information indicating that the space motion cannot be detected to the distance determination circuit 5. When the flag information is received, the circuit 5 accesses stored information indicating the previous monitor target to focus the stereo cameras of the camera 1 on the stored previous position of the monitor target. The circuit 5 then conducts the distance determination for the motion area of the person 103 using parallax signal b to send the stored space motion area to the mask determination circuit 6.

Although the flag indicating that the space motion area cannot be detected is valid, the mask determination circuit 6 receives distance information as an input thereto. If it is determined that the distance information included in the space motion area is smaller than the distance information included in the space mask area, the mask determination circuit 6 produces information indicating that the mask processing circuit 7 executes the mask processing in a range obtained by excluding the previous space motion area of the person 103. As a result, the person 103 is displayed on the screen of the monitor 8 as if the person 103 is existing over the mask 102.

Section (h) of FIG. 4 shows an image displayed on the monitor 8 when the person 103 passes the space mask area 102 and enters the house through the window. Section (h′) of FIG. 4 shows an image by adding an image of the monitor target viewed from above, i.e., the person 103 has entered the house.

The person 103 is detected by the motion detecting circuit 2 and the distance determination circuit 5. The space motion area of the person 103 and the information of distance included in the area are sent to the mask determination circuit 6. If the mask determination circuit 6 determines the distance information of the person 103 is larger than the distance information of the space mask area 102, the mask processing circuit 7 executes the mask processing only for the mask area 102, and hence the mask area 102 is displayed on the screen of the monitor 8.

As above, the area to be masked can be determined by the motion detecting circuit 2 and the mask determination circuit 6.

According to the first embodiment, by disposing the motion detection processing function to detect a motion also including information of depth and the distance determination function for the detected space motion area, there is provided an imaging device to implement privacy mask processing for a desired mask area and an unspecified monitor target on the basis of a three-dimensional mutual positional relationship.

### Second Embodiment

Description will now be given of a second embodiment, specifically, a monitor system including, in addition to the functions of the first embodiment shown in the block diagram of FIG. 1, image processing functions including a function to detect congestion and a function to detect a face as well as an alarm device.

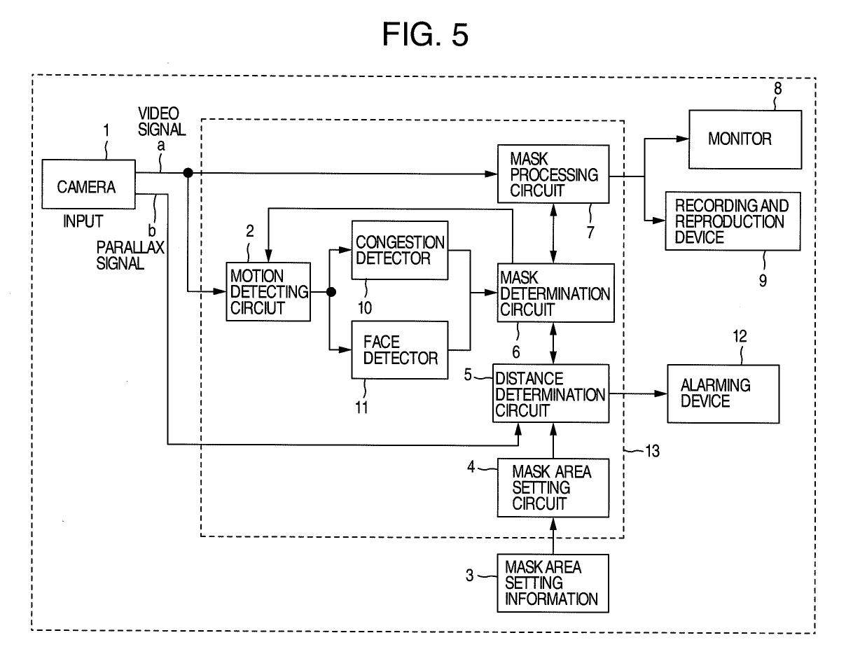

FIG. 5 is a block diagram of an imaging device according to the second embodiment including, after the motion detecting unit 2 of the block diagram of FIG. 1, a congestion detecting unit 10 to cope with a state of congestion for a fixed period of time and a face detecting unit 11 to determine whether or not the motion detection target is a human to thereby appropriately determine the monitor target. In the description below, the duplicated part of description as that of the first embodiment will be avoided.

The congestion detecting unit 10 is a circuit to detect an abnormal state, namely, assumes an abnormal state if a person or an object keeps staying at a position for a fixed period of time. The circuit 10 includes, for example, an ASIC.

The face detecting circuit 11 registers, for example, information items respectively of contours of faces of persons, distributions of colors, and brightness or lightness. The circuit 11 compares such items with associated items of a moving object to produce information to determine whether or not the mask processing is executed for the moving object. The circuit 11 includes, for example, an ASIC.

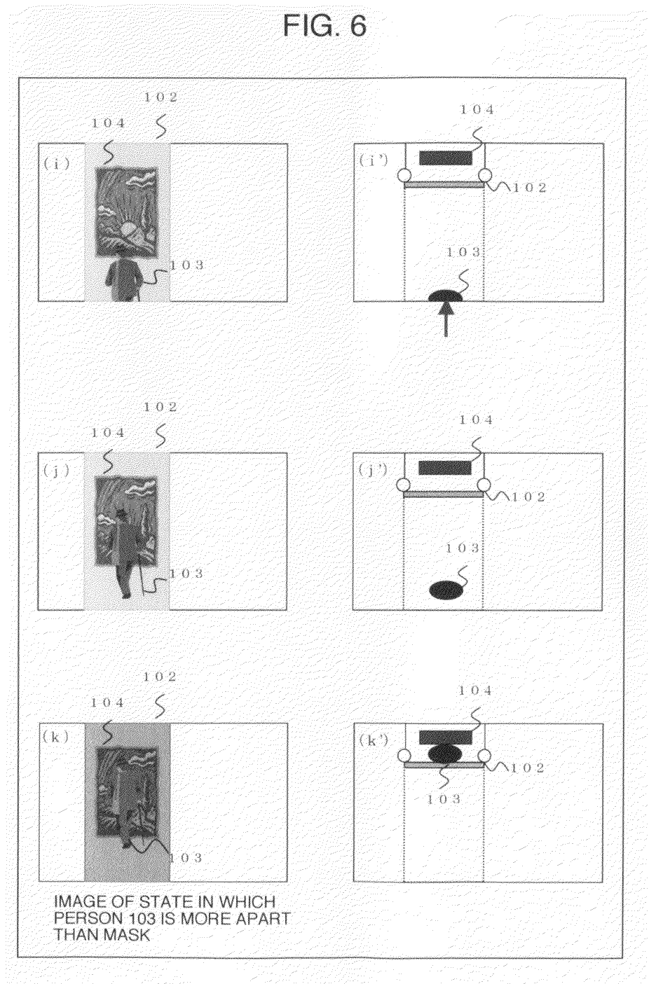

Referring now to FIG. 6, description will be given of an example of processing of the imaging device according to the second embodiment.

FIG. 6 shows an example of a mask processing method for privacy protection in an art museum employing the imaging device. In this example, to prevent drawings or pictures from being stolen, a boundary region of an entry inhibited area disposed before a work of art is defined as a space mask area such that if someone enters the inhibited area, an alarm or the like sounds.

Section (i) of FIG. 6 is an image in which an invisible space mask area 102 is set between a picture 104 to be protected and a person 103 viewing the picture. Section (i′) of FIG. 6 is an image of (i) of FIG. 6 viewed from above in which the space mask area 102 exists between the person 103 and the picture 104.

In (j) and (j′) of FIG. 6, the person 103 approaches the picture 104, but does not reach the space mask area 102. The motion of the person 103 is precisely analyzed to be detected by the motion detecting circuit 2, the congestion detecting circuit 10, and the face detecting circuit 11. Thereafter, the distance determination circuit 5 conducts the distance detection, the mask determination circuit 6 determines that the person 103 is in front of the mask area 102, and the mask processing circuit 7 executes processing to display the person 103 and the picture 104 on the monitor 8.

In (k) and (k′) of FIG. 6, the person 103 is approaching the picture 104 through the space mask area 102. At this point, the mask determination circuit 6 determines that the person 103 overlaps with the mask area 102 in the three-dimensional space or the person 103 has passed the mask area 102. If the person 103 has passed the mask area 102, the face detecting circuit 11 determines whether or not the face of the person 103 has already been registered. If it is determined that the face has not been registered, the face detecting unit 11 guides and notifies the condition using the alarm notifying device 12, for example, by sounding a siren, by blinking a lamp, or by producing voice and sound. Also, the mask processing circuit 6 releases the mask for the area in which the person 103 exists. If it is determined that the face has been registered, for example, if the face is a face of an authorized person of the art museum, it is possible that the face detecting circuit 11 does not release the mask so that the person of the museum can take an appropriate measure.

As above, in the imaging device of the embodiment, an image of a person whose face has not been registered to the face detecting circuit 11 is regarded as an image not to be protected, and hence the mask is released.

Moreover, if the person 103 is in front of the space mask area 102, the imaging device keeps execution of the mask processing for the person 103. If the person 103 moves to a position behind the mask area 102, it is possible that the imaging device releases the mask for any image for which the privacy protection is not required. For example, by setting the area before the picture as the space mask area, the imaging device conducts the mask processing for a person who is viewing the picture before the space mask area. Also, the imaging device can execute the mask processing by excluding the mask over the image including a person who approaches the picture and who is likely to make contact with the picture. In this method, the smaller the number of persons who approach the picture, the lower the load imposed on the processing to exclude the mask area is. This leads to reduction of execution of the processing not actually required.

The device may also be configured such that the mask processing is executed for the person 103 moved to a position behind the space mask area 102; thereafter, by use of the congestion detecting circuit 10, the mask processing is released for the person 103 who is remaining in such deep position for at least a fixed period of time.

As above, the monitoring operation can be performed without damaging the monitor function by the mask processing for privacy protection. Since the mask may also be regarded as an alarm line, if the moving object passes the mask area, it is possible to assume the condition as an abnormality to thereby activate an alarm function.

The imaging device of the embodiment may further include, in place of or in addition to the motion detecting circuit 2, a human detecting unit which detects, by paying attention to the head of a human, the contour and the form of the head to detect a person and which detects an action according to a change in the contour of the moving object and a change in luminance thereof. The person detected by the human detecting unit may be set as the monitor object.

### Third Embodiment

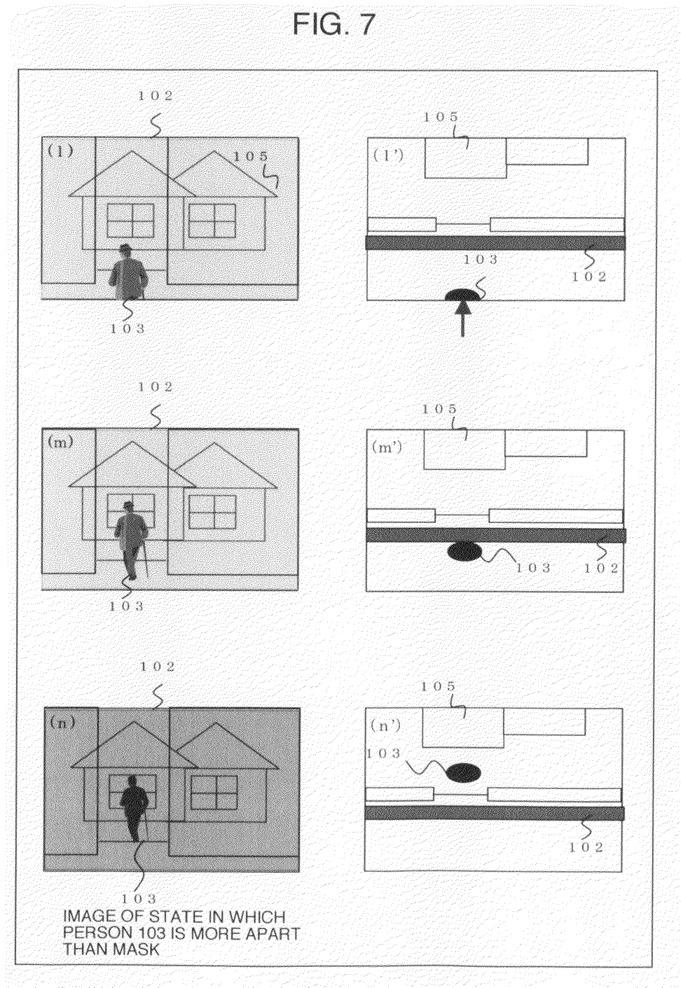

Description will now be given of a third embodiment of the monitor system in which based on the functions of the second embodiment shown in the block diagram of FIG. 5, the handling of the space mask area is changed. FIG. 7 shows an example of the mask processing in the embodiment when an area ranging from a floor of a bank to the outside thereof is photographed. In the embodiment, the space mask area 102 is arranged in a boundary zone of the internal area of the bank disposed before a window or an automatic door as an outer wall of the bank.

Section (1) of FIG. 7 shows an image in which an invisible space mask area 102 is set between the outside scene 105 to be protected and the person 103. Section (1′) of FIG. 7 is an image of (1) of FIG. 7 viewed from above in which the space mask area 102 exists between the person 103 and the scene 105.

Sections (m) and (m′) of FIG. 7, the person 103 approaches the external building 105 which is outside the bank and which is to be protected. The person 103 however does not reach the space mask area 102. The motion of the person 103 is precisely analyzed to be detected by the motion detecting circuit 2, the congestion detecting circuit 10, and the face detecting circuit 11. Thereafter, the distance determination circuit 5 conducts the distance detection, the mask determination circuit 6 determines that the person 103 is in front of the mask area 102, and the mask processing circuit 7 executes processing to display the person 103 and the picture 104 on the monitor 8. Moreover, to keep the place of the building 105 secret, the building 105 is protected by a privacy mask.

In (n) and (n′) of FIG. 7, the person 103 passes the space mask area 102 and approaches the outside building 105 to be protected.

In this situation, by beforehand registering to the face detecting circuit 11 faces of clerks and the like of the bank and those of neighborhood persons frequently visiting the bank, the photographed image can be displayed without releasing the space mask area while sustaining the privacy irrespectively of movement or the like of the person 103.

On the other hand, by use of the mask determination circuit 6, it is possible to register a face of, for example, a criminal on the wanted list to the face detecting circuit 11. In a situation wherein the person 103 is a person who is likely to be the criminal, if the person 103 overlaps with the mask area 102 or if it is determined that the person 103 passes the mask area 102 in the direction toward the imaging device, an alarm notifying device 12 guides and notifies the condition, for example, by sounding a siren, by blinking a lamp, or by producing voice and sound. Or, the device 12 may cooperate with the system to keep the automatic door closed.

In contrast therewith, if the person 103 is in front of the mask area 102, the imaging device may conduct operation as follows while sustaining the mask processing. That is, if the person 103 is behind the mask area, the imaging device may release the space mask area for an image for which the mask area is not to be protected. In this situation, for example, by setting an area before the entrance of the bank as the space mask area, the imaging device executes ordinary mask processing for the person 103. If the person 103 is a person who is likely to be the criminal, the mask processing may be executed by excluding the area of the person 103. In either cases, i.e., regardless of whether the position of the person 103 is in front of the space mask area or is moved to the space mask area, the mask processing may be carried out while excluding the area of the person 103 on the mask processing.

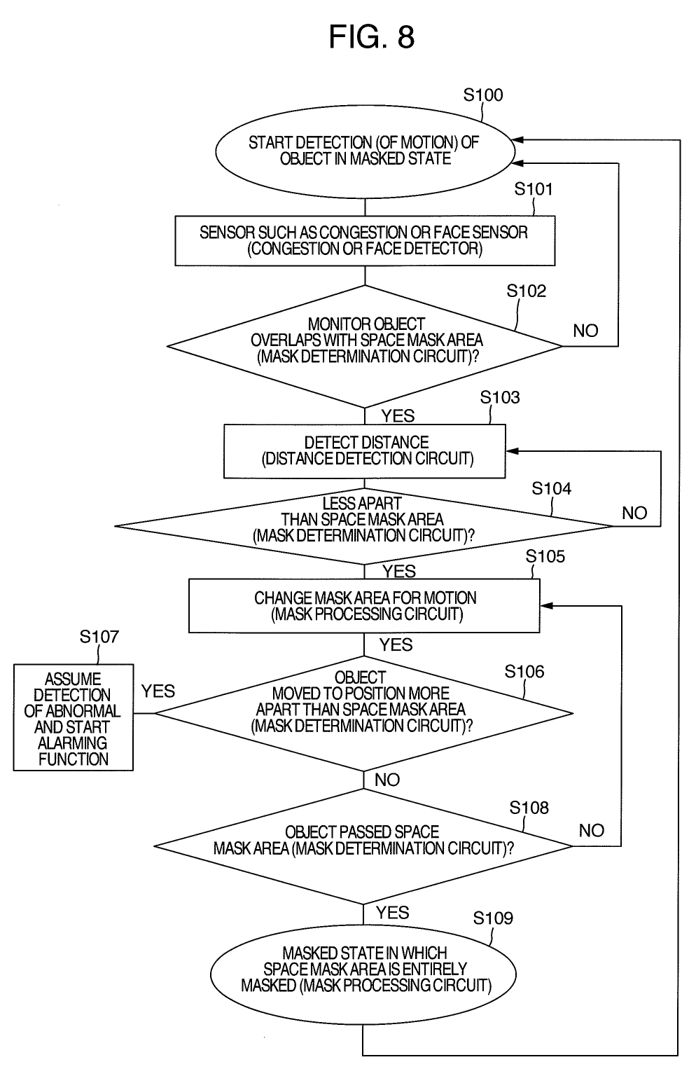

FIG. 8 is a flowchart showing an example of an operation flow from when the monitor operation is started to when the mask processing is executed in the second embodiment.

When the operation is started, an object is detected on the monitor image produced after the mask processing (step S100).

If an object such as a person appears on the monitor screen, the object is recognized by a sensor, i.e., a foreign item sensor or a face sensor (step S101).

A check is made to determine whether or not the object overlaps with the area for the mask processing in the photographed two-dimensional image. If the object overlaps with the area, the imaging device returns to an ordinary state (to step S100). Otherwise, the distance of the object is detected (step S103).

Thereafter, a check is made to determine whether or not the object is in front of the space mask area relative to the imaging device (step S104). If the object is behind the space mask area, the distance is detected according to necessity (step S103). If the object is in front of the space mask area, the mask area is changed for the motion (step S105). In this connection, “the mask area is changed” indicates that the mask processing is released for an area of the object in the area masked for privacy protection on the image.

A check is then made to determine whether or not the object has moved to a position behind the space mask area (step S106). If this is the case, it is assumed that an abnormality is detected and the alarming function is activated (step S107). Otherwise, a check is made to determine whether or not the object has passed the space mask area (step S108). If the target has passed the mask area, the area to be masked is changed for the motion (to step S105). Otherwise, the imaging device returns to an ordinary state (from step S109 to step S100).

The mask processing is executed in the order described above. According to the flowchart, if the space mask area is part of the screen, since the distance detection is initiated after it is determined that the mask area overlaps with the object, the present embodiment advantageously mitigates the processing load as compared with the case in which the distance detection is performed in any situation.

In accordance with each of the embodiments, the mask processing is executed depending on whether or not the mobile object overlaps with the mask protection target on the image and which one of the mobile object and the mask protection target is less apart from the imaging device. That is, the mask processing can be carried out on the basis of the three-dimensional positional relationship between the privacy protection target and the moving object. Whether or not the mask is set to the moving object is determined according to whether or not the moving object is in front of the space mask area. Therefore, the mask setting operation can be appropriately performed even in a situation wherein the moving object stays at a position before the protection target for a long period of time and then starts moving again.

The camera of each of the embodiments makes it possible to solve the problem below. In a case wherein whether or not the mask processing is executed is determined on the basis of only the positional relationship on the two-dimensional image, if the motion area is included in the mask area on the two-dimensional image and the object to be monitored passes the mask area in a direction to approach the imaging device or to leave therefrom, it is difficult to determine whether or not the object is to be excluded from the mask area. Concretely, in a case wherein the window is the privacy mask protection target and the moving person moves an area including the window in the direction to approach the imaging device or to leave therefrom, there occurs a problem. That is, only the two-dimensional position relationship is employed, it is difficult to determine whether or not the mask processing is executed for the person. In contrast therewith, according to the imaging device of the embodiments, the area for the mask processing is determined on the basis of the three-dimensional positional relationship. Hence, even if the moving object moves as described above, it is possible to appropriately determine the area for the mask processing.

Although description has been given of an imaging device in conjunction with FIGS. 1 and 5, it is possible that for example, the camera 1, the monitor 8, and the alarm notifying device may be replaced by other devices. For example, the image processor 13 of the monitor system may include the mask processing circuit 7, the motion detecting circuit 2, the mask determination circuit 6, and the mask area setting circuit 4.

The embodiments described above may be individually implemented or an appropriate combination thereof may also be employed.

It should be further understood by those skilled in the art that although the foregoing description has been made on embodiments of the invention, the invention is not limited thereto and various changes and modifications may be made without departing from the spirit of the invention and the scope of the appended claims.

1. An image processor for executing mask processing for an image, comprising:
an input unit for inputting an image signal produced from a camera;
a setting unit for setting a mask protection target as a target of the mask processing;
an input unit for inputting first distance information indicating distance from the camera to the mask protection target;
a detecting unit for detecting a monitor object included in the image signal;
a calculating unit for calculating second distance information indicating distance from the camera to the monitor object; and
an area determining unit for determining an area for which the mask processing is to be executed, on the basis of a position relationship between the mask protection target and the monitor object on an image photographed by the camera and a result of comparison between the first distance information and the second distance information.

2. An image processor according to claim 1, wherein:
the detecting unit is a motion detecting unit for detecting a moving object which moves in an imaging space; and
the monitor object is the moving object.

3. An image processor according to claim 1, wherein:
the detecting unit is a person detecting unit for detecting a person in an imaging space; and
the monitor object is the person.

4. An image processor according to claim 1, comprising a face detecting unit for detecting a face of a person, wherein
the monitor object is the person whose face is detected by the face detecting unit.

5. An image processor according to claim 1, wherein the image processor executes, if the mask protection target overlaps with the monitor object on the photographed image and the second distance information indicates a value larger than a value indicated by the first distance information, the mask processing by excluding an overlapped portion between the mask protection target and the monitor object on the photographed image.

6. An image processor according to claim 1, wherein the image processor executes, if the mask protection target overlaps with the monitor object in the photographed image and the second distance information indicates a value smaller than a value indicated by the first distance information, the mask processing by excluding an overlapped portion between the mask protection target and the monitor object in the photographed image.

7. An image processor according to claim 1, wherein if the mask protection target overlaps with the monitor object in the photographed image and the second distance information indicates a value larger than a value indicated by the first distance information, the image processor produces and transmits an indication signal indicating that an alarm notifying device issues an alarm or a notification.

8. An imaging device comprising an image processor according to claim 1.

9. An image processor for executing mask processing for an image, comprising:
an input unit for inputting an image signal produced from a camera;
a determining unit for determining a mask protection target for which the mask processing is to be executed in an imaging space;
a detecting unit for detecting a monitor object included in the image signal;
a position relationship measuring unit for measuring a position relationship between the mask protection target and the monitor object in the imaging space; and
a mask determining unit for determining whether or not the mask processing is to be executed for the monitor object, on the basis of a three-dimensional position relationship between the mask protection target and the monitor object in the image signal.

10. An image processor for executing mask processing for an image, comprising:
an input unit for inputting an image signal produced from a camera;
a space mask area setting unit for setting a space mask area indicating a partial area of a space as an object of imaging operation of the camera;
an input unit for inputting first distance information indicating distance from the camera to a position indicated in the space mask area;
a detecting unit for detecting a monitor object included in the image signal;
a calculating unit for calculating second distance information indicating distance from the camera to the monitor object; and
an area determining unit for determining an area for which the mask processing is to be executed, on the basis of a position relationship between the space mask area and the monitor object on an image photographed by the camera and a result of comparison between the first distance information and the second distance information.
